(19) United States
(12) Patent Application Publication
(10) Pub. No.: US 2026/0326136 A1
(43) Pub. Date: Oct. 22, 2026

(54) SPRAY NOZZLE

(71) Applicant: Bete Fog Nozzle, LLC, Greenfield, MA (US)

(72) Inventors: Cameron Sean LANDERS, Leominster, MA (US); Mead Tucker LANDIS, Northampton, MA (US)

(21) Appl. No.: 19/107,702

(22) PCT Filed: Sep. 1, 2023
(86) PCT No.: PCT/US2023/031829

§ 371 Date: Feb. 28, 2025

Related U.S. Application Data
(60) Provisional application No. 63/374,427, filed on Sep. 2, 2022.

(51) Int. Cl. B05B 13/06; B05B 3/04; B08B 9/093; F16C 19/16

(52) U.S. Cl. CPC B05B 13/0636; B05B 3/04; B08B 9/0936; B08B 2209/08; F16C 19/163

(57) ABSTRACT

A spray nozzle includes a liquid inlet, a stem extending from the liquid inlet, and a manifold rotatably mounted by a bearing on the stem. The stem defines an upper flow path upstream of the bearing, and a lower flow path downstream of the bearing. The stem includes a flange extending radially therefrom and defining an outer diameter less than the inner diameter of a reduced-diameter section of the manifold and an inner bearing surface substantially facing the liquid inlet. The reduced-diameter section of the manifold defines an outer bearing surface axially spaced from and substantially facing the inner bearing surface of the flange. The bearing is received between the inner bearing surface and the outer bearing surface and is configured to retain the rotating manifold on the stem against a liquid supply pressure of the liquid flowing into the manifold.

### CROSS-REFERENCE TO RELATED PATENT APPLICATION

This patent application claims priority under 35 U.S.C. § 119(e) to U.S. provisional patent application No. 63/374,427, filed Sep. 2, 2022, entitled “Rotating Spray Nozzle,” which is hereby incorporated by reference in its entirety as part of the present disclosure.

### FIELD OF THE INVENTION

The present invention relates to spray nozzles, and more particularly, to spray nozzles, such as tank washing nozzles that fit through openings in tanks and spray liquids in spray patterns, such as 360° spray patterns.

### BACKGROUND INFORMATION

Containers such as tanks or bottles often require cleaning of residues and debris before introducing new media to avoid contamination and maintain purity. A common way to accomplish this is to apply a spray of water or other liquid cleaning agent mixture to the walls of the tank via a nozzle. One type of nozzle is described, for example, in U.S. Pat. No. 7,063,274, where the nozzle applies cleaning solution to the tank using a substantially spherical manifold mounted on ball bearings that rotate from the torque applied to it by cleaning fluid issuing from holes or slots placed off-axis in the rotating element. This spray typically covers a spherical surface around the nozzle, although the slots or holes may be configured so that only a portion of the spherical surface is covered. Exemplary tank washing nozzles include the BETE Fog Nozzle Inc. Hydro Whirl S, Lechler Free Spinning Tank Cleaning Line, Lechler MiniSpinner 5m2, Alfa Laval SaniMidget, and Spraying Systems TankJet D41990.

Such nozzles must: (i) connect to a certain size supply pipe or tube; (ii) operate independently of mounting orientation; (iii) be appropriately sized to fit within a desired opening of a tank or bottle; (iv) maximize mechanical cleaning capacity of the nozzle through accommodating the largest possible flow capacity for a given tank size opening; (iv) rotate with reasonable service life of 300+ hours at nominal pressures (typically 30-40 psi) with clean, well-filtered water; and (v) have acceptable manufacturing costs.

Current designs are subject to a number of disadvantages. The inner diameter of the bearing element limits the flow capacity through a nozzle capable of insertion through a given tank or bottle opening size. The nozzle assembly is composed of many parts that require welding or other problematic methods of fastening that produce unhygienic surfaces, crevices, and cavities and add complexity, cost, and imbalance. The rotating element's center of mass is cantilevered from the bearings. Inevitable imbalance from the assembly and fixturing methods produce wobble, high stress, and/or consequent wear of the bearing races, leading to premature failure of the bearings.

At a fundamental level, current tank washing nozzle bearing assembly design involves a balance between (i) increasing flow capacity by decreasing flow restriction, which is typically limited by the inner diameter of the rolling bearing element, and (ii) increasing bearing life and decreasing rolling resistance by increasing the diameter of the bearing balls, which typically restricts the inner diameter of the rolling element. Typically, the ball bearing assemblies are completely housed in a connector which is sized to be as small as possible so that the nozzle can be self-washing.

Another drawback of current or prior art tank washing nozzles is that the bearing assemblies require overlapping components that are joined together at various steps in the process to maintain the location of the bearing assemblies. These assemblies can require intensive and potentially complex processes for assembly, and destructive methods for disassembly.

In prior art free-spinning tank washing nozzles, the bearings can be commonly located some distance along the axis of rotation away from the rotating mass, e.g., the manifold. This is due to manufacturing constraints from typical part joining methods and creates a cantilevered rotating mass which results in the manifold being imbalanced during operation. This imbalance increases the torque required to begin rotation and further reduces flow capacity by wasting additional kinetic energy from the supply fluid to overcome the manifold's imbalance.

Another drawback of prior art tank washing nozzles is that the bearing assemblies can have limited drainage characteristics due to compact and enclosed designs.

The drainage can be further hindered when the nozzle is not vertically oriented, resulting in stagnant fluid.

Yet another drawback encountered in the prior art is that standard threaded connection nozzles create a stagnation point for water, accumulating debris and particulate while promoting growth of biofilms. Such standard threaded connections may require thread tape that can promote the creation of biofilms, clog the nozzles and/or contaminate the process if the tape becomes dislodged.

It is an object of the present invention, and/or of embodiments thereof, to overcome one or more of the above-described drawbacks and/or disadvantages of the prior art.

### SUMMARY OF THE INVENTION

In accordance with a first aspect, the present invention is directed to a spray nozzle, such as a rotating spray nozzle, connectible in fluid communication with a liquid supply and configured to spray liquid from the liquid supply. The spray nozzle comprises a liquid inlet connectible in fluid communication with the liquid supply and configured to receive liquid therefrom. A connector or stem extends in a downstream direction relative to the liquid inlet and is in fluid communication and substantially coaxial therewith. A manifold is substantially coaxial with and extends about the stem. The manifold defines an upper interior cavity, a lower interior cavity, a plurality of spray apertures in an exterior wall thereof, and a reduced-diameter section located between the upper interior cavity and the lower interior cavity and defining a reduced inner diameter. A bearing is configured to allow the manifold to rotate about the stem. The stem defines an upper flow path upstream of the bearing and configured to introduce liquid from the stem into the upper interior cavity of the manifold, and a lower flow path downstream of the bearing and configured to introduce liquid from the stem into the lower interior cavity of the manifold. The stem includes a flange extending radially therefrom and defining an outer diameter less than the inner diameter of the reduced-diameter section of the manifold and an inner bearing surface substantially facing the liquid inlet. The reduced-diameter section of the manifold defines an outer bearing surface axially spaced from and substantially facing the inner bearing surface of the flange.

The bearing is received between the inner bearing surface and the outer bearing surface and is configured to (i) allow the manifold to rotate about the stem, and (ii) retain the rotating manifold on the stem against a liquid supply pressure of the liquid flowing into at least one of the upper interior cavity or the lower interior cavity.

In some embodiments of the present invention, the manifold is formed in one piece. In some embodiments, the manifold defines a distal end wall that curves inwardly toward an axis of rotation of the manifold. In some embodiments, the spray nozzle comprises a bearing assembly including a plurality of bearings received between the inner bearing surface and the outer bearing surface. In some embodiments, the spray nozzle comprises only one said bearing assembly.

In some embodiments of the present invention, the stem defines a plurality of fluid flow apertures therein defining at least one of the upper flow path or the lower flow path. Each of a plurality of the apertures defines at least a portion thereof extending through a substantially radially-directed wall of the stem. In some such embodiments, the apertures formed through the radially-directed wall of the stem are angled to cause the liquid flowing through the angled aperture to impart rotating motion on the manifold.

Some embodiments of the present invention further comprise a retainer located on the inlet or stem upstream of the manifold and configured to substantially prevent the manifold from moving axially relative to the stem in an upstream direction. In some such embodiments, the retainer defines (i) a service position or configuration wherein the manifold is movable axially relative to the stem to define an increased axial distance between the inner bearing surface and outer bearing surface and thereby allow the bearing to be received between the inner bearing surface and outer bearing surface, and (ii) an operational position or configuration substantially preventing the manifold from moving axially relative to the stem in an upstream direction and defining a decreased axial distance between the inner bearing surface and outer bearing surface to thereby retain the bearing between the inner bearing surface and the outer bearing surface. In some embodiments of the present invention, the inlet or stem defines a recess or groove, and the retainer is received within the recess or groove in the operational position to fix the axial position of the retainer and substantially prevent the manifold from moving axially relative to the stem in an upstream direction. In some such embodiments, the retainer is one or more of a ring, a clip, a wire, a dowel pin, a threaded, crimped or welded fastener, a rivet, a gasket or an O-ring. In some embodiments, the retainer is defined by a raised portion on one of the stem or the manifold and a reduced portion on the other of the stem or manifold and configured for receiving the raised portion. In some such embodiments, the reduced portion is formed by a swage, a weld, a crimp, a thermal deformation, or a machined part formed or spun into a retainer. For example, in some such embodiments, the connector/stem defines a groove or other recess, and the proximal or upstream end or edge of the manifold is deformed into the groove at the last stage or near the last stage of assembly to retain the manifold on the connector/stem and prevent relative axial movement. In other embodiments, one or more pins or like structures are fixed to, or received through the manifold and extend radially into the groove of the connector/stem to retain the manifold on the connector/stem and prevent relative axial movement.

In some embodiments of the present invention, the inlet defines a first pipe thread engageable with a second pipe thread of a liquid supply conduit. One of the first pipe thread or second pipe thread is configured to receive the other therein and define a continuous spiral channel between the first and second pipe threads. The continuous spiral channel is in fluid communication between the interior of the inlet or stem and the exterior of the nozzle and is configured to allow liquid to flow therethrough. In some such embodiments, the first pipe thread is a female pipe thread and the second pipe thread is a male pipe thread.

In some embodiments of the present invention, the bearing defines a center point in an axial direction of the spray nozzle, the manifold defines a center of mass, and an axial distance between the center point of the bearing and the center of mass of the manifold is less than or equal to about 150% of a diameter or width of the bearing element. In some such embodiments, the bearing includes at least one bearing race defining a width in the axial direction and at least one ball bearing defining a diameter. The axial distance between the center of mass of the manifold and the center of the bearing race or the center of the ball bearing is less than or equal to about 150% of the diameter of the ball bearing or the width of the bearing race. In some such embodiments, the center of mass of the manifold is aligned with, or located within the diameter of the ball bearing or the width of the bearing race. In some embodiments, the ball bearing(s) and bearing race(s) form a bearing assembly, and the spray nozzle includes only one said bearing assembly rotatably mounting the manifold on the stem.

In some embodiments of the present invention, the bearing includes at least one bearing race and a plurality of roller bearings configured to roll over the bearing race and thereby allow relative rotation of the manifold and stem. The bearing race defines a least one serration or divot configured to contact the roller bearings as they roll over the bearing race. The serration or divot defines a peripheral shape configured to change the speed of the roller bearings as they roll across the serration or divot and thereby separate the roller bearings. In some such embodiments, the serration or divot defines a substantially elliptical peripheral shape. In some embodiments, the bearing race defines a plurality of serrations or divots angularly spaced relative to each other Each serration or divot defines a roller bearing entry point at approximately one end thereof, and a roller bearing exit point at approximately another end thereof. At least one transition groove extends between angularly spaced serrations or divots and is configured to contact the roller bearings and approximately align the roller bearings with at least one of the entry point or exit point of a respective serration or divot.

In accordance with another aspect, the present invention is directed to a method of assembling a spray nozzle, such as a rotating spray nozzle, comprising:
(i) introducing at least one bearing into a lower interior cavity of a manifold;
(ii) inserting a distal end of a stem into at least an upper interior cavity of the manifold, locating a relative position of the manifold and stem into a first position defining an increased space between an inner bearing surface and an outer bearing surface, and tilting or moving the nozzle relative to the horizontal to cause the bearing to be received into the increased space between the inner bearing surface and outer bearing surface; and
(iii) moving the manifold and/or stem relative to the other into a second position defining a decreased space between the inner bearing surface and outer bearing surface and retaining the bearing between the inner bearing surface and the outer bearing surface.

Some embodiments of the present invention further comprise the step of preventing the manifold from moving axially relative to the stem in an upstream direction and thereby retaining the manifold in the second position.

In accordance with another aspect, the present invention is directed to a spray nozzle, such as a rotating spray nozzle, connectible in fluid communication with a liquid supply and configured to spray liquid from the liquid supply. The spray nozzle comprises first means connectible in fluid communication with the liquid supply for receiving liquid therefrom. Second means extend in a downstream direction relative to the first means and are in fluid communication and substantially coaxial therewith for receiving liquid therefrom.

Third means are substantially coaxial with and extend about the second means for receiving liquid therefrom, rotating about the second means, and emitting the liquid in a spray. The third means defines an upper interior cavity, a lower interior cavity, a plurality of spray apertures in an exterior wall thereof, and a reduced-diameter section located between the upper interior cavity and the lower interior cavity and defining a reduced inner diameter. The spray nozzle further comprises fourth means for allowing the third means to rotate about the second means. The second means defines an upper flow path upstream of the fourth means and configured to introduce liquid from the second means into the upper interior cavity of the third means, and a lower flow path downstream of the fourth means and configured to introduce liquid from the second means into the lower interior cavity of the third means. The second means includes fifth means extending radially therefrom and defining an outer diameter less than the inner diameter of the reduced-diameter section of the third means for providing an inner bearing surface substantially facing the first means. The reduced-diameter section of the third means defines an outer bearing surface axially spaced from and substantially facing the inner bearing surface of the fifth means. The fourth means is received between the inner bearing surface and the outer bearing surface for (i) allowing the third means to rotate about the second means, and (ii) retaining the rotating third means on the second means against a liquid supply pressure of the liquid flowing into at least one of the upper interior cavity or the lower interior cavity.

In some embodiments of the present invention, the first means is a liquid inlet, the second means is a connector or stem, the third means is a manifold, the fourth means is a bearing and the fifth means is a flange. Some embodiments of the present invention further comprise sixth means for preventing the third means from moving axially relative to the second means in an upstream direction.

In accordance with another aspect, the present invention is directed to a spray nozzle connectible in fluid communication with a liquid supply conduit and configured to spray liquid from the liquid supply conduit. The spray nozzle comprises a liquid inlet connectible in fluid communication with the liquid supply conduit and configured to receive liquid therefrom. A stem extends in a downstream direction relative to the liquid inlet and is in fluid communication therewith. A manifold is mounted on the stem and defines at least one interior cavity in fluid communication with the stem and at least one spray aperture in an exterior wall thereof in fluid communication with the interior cavity for receiving liquid therefrom and emitting a spray. The inlet or stem defines a first pipe thread engageable with a second pipe thread of the liquid supply conduit. One of the first pipe thread or second pipe thread is configured to receive the other therein and define a continuous spiral channel between the first and second pipe threads. The continuous spiral channel is in fluid communication between the interior of the inlet or stem and the exterior of the nozzle and is configured to allow liquid to flow therethrough. In some such embodiments, the first pipe thread is a female pipe thread and the second pipe thread is a male pipe thread. In some embodiments, the manifold is rotatably mounted on the stem.

One advantage of the spray nozzle of the present invention, and/or of embodiments thereof, is that the spray nozzle may use a rolling element, such as the ball bearings, as an assembly item to constrain two items without overlapping diameters, i.e., the manifold and connector/stem. Another advantage is that the spray nozzle may use a specific internal geometry to allow assembly of the bearing. In some such embodiments, the bearing balls restrict concentricity and axial movement in one direction. After the bearing balls are assembled into the nozzle, a retaining mechanism restricts the remaining axial direction of freedom. The retaining mechanism may take any of numerous different configurations that are currently known, or that later become known, including without limitation: (1) An internal swage where the connector is expanded: (a) by an axial-expander die; (b) by a multi-segment radial expander die; (c) by a roller-swage method; or (d) by a hydraulic forming method (e.g., hydroforming). (2) An external swage: (a) by an axial-shrinker die; (b) by a multi-segment radial shrinker die; or (c) by a roller-swage method, such as metal spinning; or (d) by a hydraulic forming method. (3) A retaining ring; (4) A retaining clip; (5) A fastener using threads; (6) A press fit component; or (7) An o-ring.

Yet another advantage of the spray nozzle of the present invention, and/or of embodiments thereof, is that the spray nozzle can be configured to impart minimal restriction to the internal liquid flow before the final restriction of the respective spray aperture or spray orifice in the external wall of the manifold. A still further advantage of the spray nozzle is that it can enable placement of the ball bearing in the substantially largest diameter allowable of the manifold to allow maximum fluid passage (or minimal or the least restriction) through the inner diameter of the inner bearing race. This in turn allows for larger bearings that provide less rolling resistance and longer service life. In addition, this overcomes problems encountered in prior art bearing assemblies or assembly methods using geometries that can create un-hygienic crevices and cavities.

Another advantage of the spray nozzle of the present invention, and/or of embodiments thereof, is that the spray nozzle can allow for placing the center of mass of the manifold/rotating tank washing element adjacent to or within the race of the bearing. This in turn allows for horizontal mounting of the nozzle without generating a cantilevered load or requiring a doubled set of ball bearings or accelerated wear.

Yet another advantage of the spray nozzle of the present invention, and/or of embodiments thereof, is that the spray nozzle can direct some fluid flow to spray orifices before the restriction of the ball bearing inner diameter.

Another advantage of the spray nozzle of the present invention, and/or of embodiments thereof, is that the spray nozzle can include drive diffuser stator vanes or like flow apertures or paths that distribute liquid to the spray before or upstream of the bearing inner diameter restriction of the nozzle.

Yet another advantage of the spray nozzle of the present invention, and/or of embodiments thereof, is that the spray nozzle can allow for a drive diffuser stator with ball bearing rotor elements: (a) that use the stator vane (drive diffuser) to create a rotating cylinder of liquid/water washing directly over the ball bearing elements, creating a force on the bearing balls, which then pushes on the manifold as a torque to rotate the manifold; (b) which in turn creates a favorable torque curve with high starting torque that falls off quickly; and (c) where the bearings are directly and substantially consistently washed with no or substantially no dead space or slow moving liquid. Another advantage is that the spray nozzle can prevent non-spraying related wear and tear impact from being applied to the bearing elements. Rather, such impacts are absorbed by non-bearing elements and do not damage key bearing elements.

Yet another advantage of the spray nozzles of the present invention, and/or of embodiments thereof, is that the spray nozzle can have relatively low frictional losses. This allows most of the energy to be directed into spray impact and cleaning, correspondingly allowing for lower pressure usage, and/or minimization of process fluid contamination from wear debris from nozzle components.

A still further advantage of the spray nozzles of the present invention, and/or of embodiments thereof, is that the design of the spray nozzle components can allow complete access for inspection, deburring, and polishing before final assembly of the spray nozzles.

Another advantage of the spray nozzles of the present invention, and/or of embodiments thereof, is that the spray nozzles can include self-flushing threads. In some such embodiments, approximately 50% depth threads allow an intentional cleansing leakage path along the thread. This can overcome the problems encountered in the prior art where some orientation angles of the spray nozzles have stagnant water due to conventional pipe thread seals, and can eliminate the need for pipe tape which can contaminate the spray nozzle processes, such as tank washing, and can cause clogs.

Other advantages of the present invention, and/or of embodiments thereof, will become more readily apparent in view of the followed detailed description of embodiments of the invention and accompanying drawings.

### BRIEF DESCRIPTION OF THE DRAWINGS

FIG. 1 is a cross-sectional, somewhat perspective view of a rotating spray nozzle embodying the present invention without a retainer constraining axial movement of the manifold;

FIG. 2 is a cross-sectional, somewhat perspective view of the rotating spray nozzle of FIG. 1 showing a retainer, such as a retaining ring, assembled into a locking groove to prevent upstream axial movement of the manifold on the connector/stem;

FIG. 3 is an alternative embodiment of the rotating spray nozzle of FIGS. 1 and 2 including a v-clip in lieu of the retaining ring of FIG. 2 to prevent upstream axial movement of the manifold on the connector/stem, and including another v-clip to connect the liquid supply conduit to the inlet of the connector/stem in lieu of a pipe thread connection, where the v-clip design maintains hygienics by making the spray nozzle fully-self washing and without crevices external to the part/fluid flow;

FIG. 4 is a partial, cross-sectional, somewhat perspective view of another alternative embodiment of the rotating spray nozzle of FIGS. 1 and 2 where the connector includes swaging deformation and a post-swaging retaining surface, in lieu of the retaining ring of FIG. 2 or other retainer, to prevent upstream axial movement of the manifold on the stem;

FIG. 5 is another cross-sectional, somewhat perspective view of the rotating spray nozzle of FIGS. 1 and 2;

FIG. 5A is an enlarged, partial, cross-sectional view of the bearing assembly of the rotating spray nozzle of FIG. 5;

FIGS. 6A and 6B are cross-sectional, perspective views of the rotating spray nozzle of FIGS. 1 and 2 showing the first and second steps, respectively, of assembling the nozzle;

FIGS. 6C and 6D are cross-sectional, perspective views of the rotating spray nozzle of FIGS. 1 and 2 showing the third step of assembling the nozzle;

FIGS. 6E and 6F are cross-sectional, perspective views of the rotating spray nozzle of FIGS. 1 and 2 showing the fourth and fifth steps, respectively, of assembling the nozzle;

FIG. 7A is a side elevational, somewhat perspective view of an alternative embodiment of the spray nozzles of FIGS. 1 and 2 where the manifold is created around the connector/stem, with ball bearings already in place, by metal spinning/hydroforming;

FIG. 7B is a partial cross-sectional, somewhat perspective view of the rotating spray nozzle of FIG. 7A;

FIG. 8 is a partial cross-sectional, somewhat perspective view of another alternative embodiment of the rotating spray nozzle of FIGS. 1 and 2 where the manifold is a two component part, where one component defines the upper internal cavity, reduced diameter section, and outer bearing race, and the other component defines the lower internal cavity, and the two components are joined before or after assembling the bearing by any of numerous different joining methods that are currently known, or that later become known, such as by welding, friction, threads, additional pins, clips or fasteners;

FIG. 9A is an end elevational view of the manifold of the rotating spray nozzle of FIGS. 1 and 2;

FIG. 9B is a cross-sectional view of the manifold of FIG. 9A taken along line A-A thereof;

FIG. 10A is an end elevational view of the connector/stem of the rotating spray nozzle of FIGS. 1 and 2;

FIG. 10B is a cross-sectional view of the connector/stem of FIG. 10A taken along line A-A thereof;

FIG. 11 is another cross-sectional, somewhat perspective view of the spray nozzle of FIGS. 1 and 2 illustrating with arrows the process fluid paths through the nozzle where the reduced diameter section at the distal end of the connector/stem directs a portion of the liquid flow from the connector/stem into the upper hemisphere/cavity of the manifold for an upper spray, the liquid flows through the reduced diameter section at the distal end of the connector/stem into the lower hemisphere/cavity of the manifold for a lower spray, and the liquid flow continuously flushes and lubricates the bearings;

FIG. 12 is a cross-sectional, somewhat perspective view of the manifold of the rotating spray nozzle of FIGS. 1 and 2 depicting the location of the center of mass of the manifold within the bearing element;

FIG. 13 is a partial, cross-sectional, somewhat perspective view of the rotating spray nozzle of FIGS. 1 and 2 showing the hygienically designed pipe threads defining a continuous spiral channel along the thread that allows fluid to drain during and after a cleaning operation;

FIG. 14A is partial, perspective view of the connector/stem of the rotating spray nozzle of FIGS. 1 and 2 showing the drive diffuser slots and the bearings on the inner race;

FIG. 14B is an end elevational view of the connector/stem and bearings of FIG. 14A showing with arrows the direction of liquid flow through the drive diffuser slots and over the bearings;

FIG. 15A is a cross-sectional, somewhat perspective view of the rotating spray nozzle of FIGS. 1 and 2 showing the liquid flow around and through the bearings;

FIG. 15B is an enlarged, partial cross-sectional view of the spray nozzle of FIG. 15A further illustrating the process liquid flow through the drive diffuser slots, and how the bearings act as rotor vanes;

FIG. 16A is a partial, perspective, cross-sectional view of an alternative embodiment of the rotating spray nozzle of FIGS. 1 and 2 including serrations/divots on the inner race of the bearing assembly, and transition grooves located between the serrations/divots, to change the speed of the bearings as they travel across the serrations/divots and facilitate separation of the bearings;

FIG. 16B is an enlarged partial, perspective, cross-sectional view of a ball bearing and serration/divot of FIG. 16A;

FIG. 17A is an enlarged, partial view a serration/divot and transition groove of FIG. 16A;

FIG. 17B is an enlarged view of a serration/divot of FIG. 16A;

FIGS. 18A through 18C are a series of cross-sectional views of an alternative embodiment of the spray nozzle of FIGS. 1 and 2 having a different shaped manifold, and different shaped spray orifices in the manifold;

FIG. 18D is an exploded, perspective view of the connector/stem and manifold of the rotating spray nozzle of FIGS. 18A-18C prior to assembly;

FIG. 18E is a somewhat perspective, cross-sectional view of the spray nozzle of FIG. 18C with the connector/stem inserted into the manifold;

FIG. 18F is a perspective view of the assembled spray nozzle of FIG. 18C;

FIG. 19 is a perspective, cross-sectional view of the spray nozzle of FIGS. 1 and 2 including a bearing cage to maintain separation of the ball bearings; and

FIG. 20 is a perspective, cross-sectional view of an alternative embodiment of a spray nozzle of the present invention including a sliding bearing in lieu of roller or ball bearings as in the embodiment of FIGS. 1 and 2.

### DETAILED DESCRIPTION

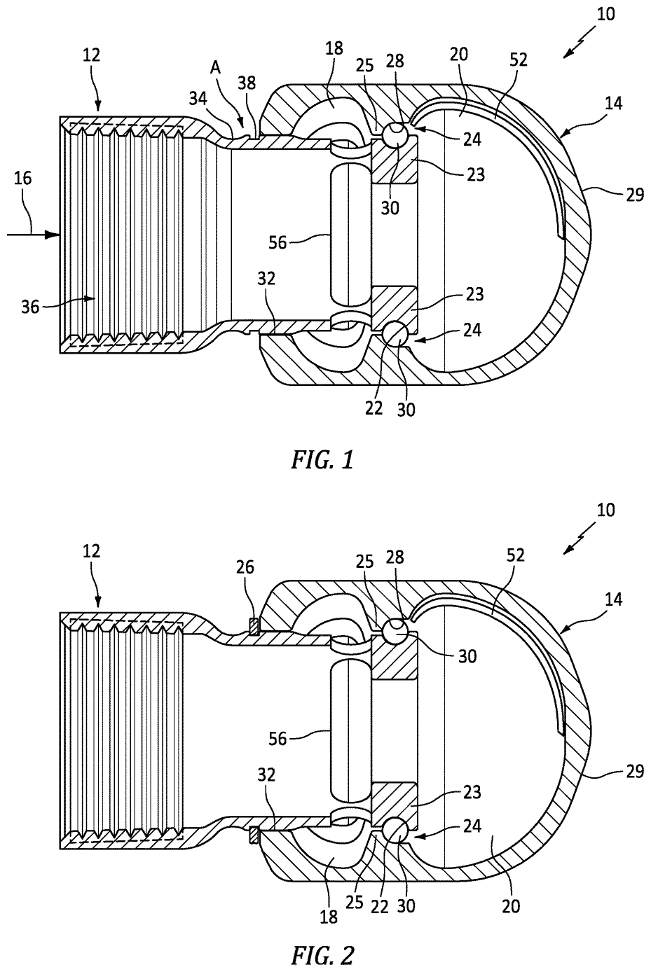

In FIGS. 1 and 2, a spray nozzle embodying the present invention is indicated generally by the reference numeral 10. The spray nozzle 10 comprises two non-standard components: a connector or stem 12 and manifold 14.

The connector 12 functions to join a fluid supply 16 and the manifold 14. The connector 12 distributes flow to the upper and lower sections/cavities/hemispheres 18 and 20, respectively, of the manifold 14, includes the geometry of an inner race 22 of a ball bearing element 24, geometry to aid in assembling the ball bearing element 24, and geometry to allow the assembly to be secured by way of a retainer 26, such as a retaining ring or swaging.

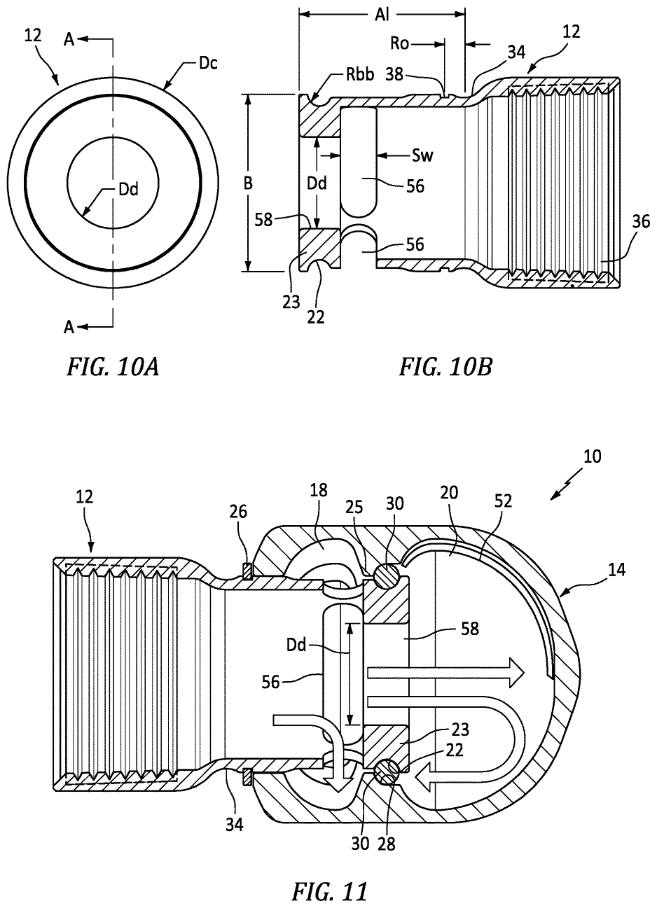

The manifold 14 functions to direct the supplied fluid 16 to the desired spray propagation angles, rotate coaxially to the supply outlet to distribute the spray propagation plane(s), and be the final restriction to the fluid flow. Spray propagation angles include coverages of up to or including 360°. The manifold 14 includes geometry of an outer race 28 of the ball bearing element 24, geometry to aid in assembling the ball bearing element, and geometry to allow the assembly to be secured by way of the retainer 26, such as the retaining ring or swaging. The inner and outer bearing races 22 and 28, respectively, are non-overlapping and are designed to freely slide past one another for assembly. As shown typically in FIGS. 9B and 10B, the connector or stem 12 includes a flange 23 extending radially therefrom defining an outer diameter “B” less than an inner diameter “A” of the reduced-diameter section 25 of the manifold 14. As can be seen, the inner bearing surface 22 substantially faces the liquid inlet of the spray nozzle 10, and the reduced-diameter section 25 of the manifold 14 defines the outer bearing surface 28 axially spaced from and substantially facing the inner bearing surface 22 of the flange 23.

As may be recognized by those of ordinary skill in the pertinent art based on the teachings herein, the manifold 14 may take any of numerous different configurations, and may be caused to rotate in any of numerous different ways, that are currently known, or that later become known. For example, the means of providing rotation may be the action of the liquid exiting the inlet/stem into the cavity or cavities of the manifold. Alternatively, the rotation may be caused by angling the apertures on the manifold. The manifold 14 includes a closed distal or downstream end 29. However, as may be recognized by those of ordinary skill in the pertinent art based on the teachings herein, the downstream end 29 of the manifold 14 need not be closed, but may be open or may otherwise define one or more openings therein. For example, the downstream end 29 of the manifold may define aperture(s) therein to emit a spray therethrough and configured to clean directly under or beneath the spray nozzle 10. One advantage of the disclosed configuration of the manifold is that the downstream end wall curves radially inwardly toward the center or axis of rotation of the manifold to direct the flow of liquid within the manifold and through the spray aperture(s) formed therein.

The nozzle 10 includes a plurality of standard-component bearing balls 30, 30 that, when properly seated in the ball bearing element 24 geometry, function to facilitate the rotary motion of the manifold 14 and prevent the nozzle 10 from being disassembled. The bearings 30, 30 are received between the inner bearing surface 22 and the outer bearing surface 28 and are configured to (i) allow the manifold 14 to rotate about the stem 12, and (ii) retain the rotating manifold 14 on the stem 12 against the liquid supply pressure of the liquid flowing into the interior cavity or cavities of the manifold. Thus, as shown typically in FIG. 11, while the nozzle assembly 10 is under an axial tensile load, the bearings 30, 30 act as an overlapping surface to prevent the two components (i.e., the connector 12 and manifold 14) from separating.

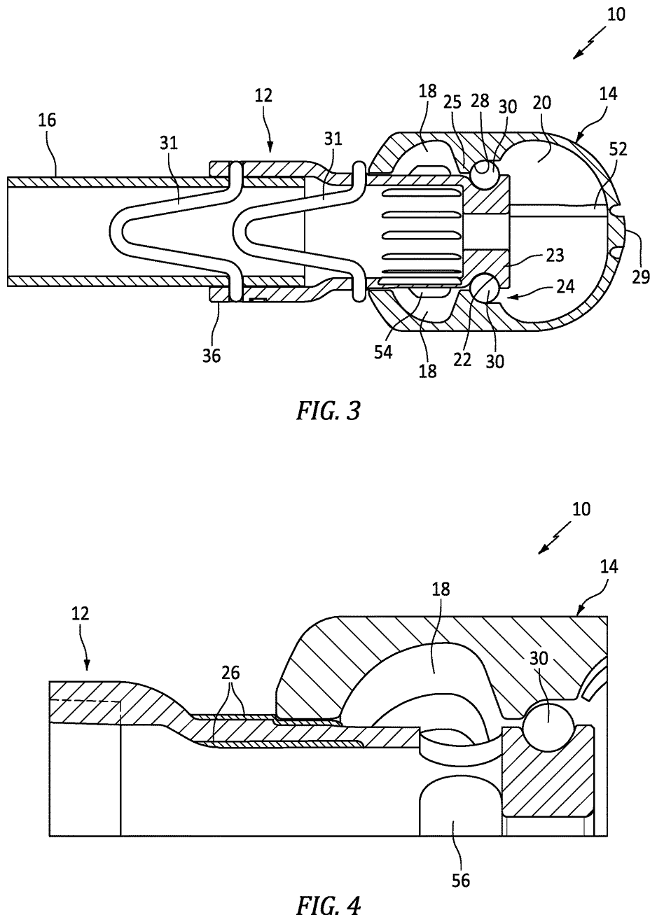

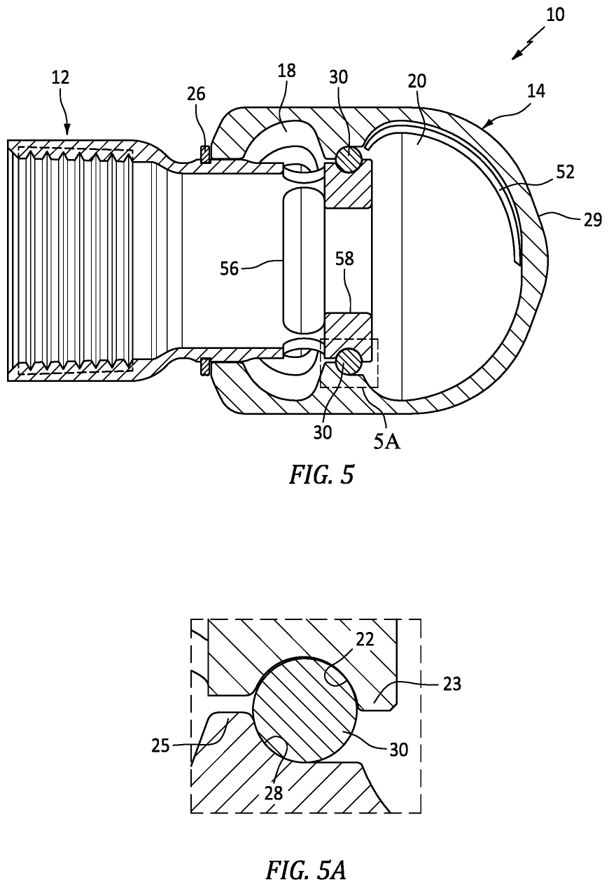

As shown typically in FIGS. 1 and 2, to prevent nozzle disassembly while the nozzle assembly 10 is under an axial compression load, the retainer 26 or other proud surface is introduced at location “A” after the bearing element 24 has been assembled. The retainer or proud surface 26 is offset from the manifold 14 a constrained distance relative to the dimensions of the internal bearing geometry. Unless a load is applied in the above-mentioned interference direction of the two parts (i.e., the connector 12 and manifold 14), the retainer or proud surface 26 should not be touching the manifold 14 so that it will not affect the rotary motion of the manifold and thus of the nozzle. The retainer or proud surface 26 can be introduced by any of numerous different methods that are currently known, or that later become known to those of ordinary skill in the pertinent art based on the teachings herein, such as by applying a permanent, or non-permanent retaining ring at location “A,” or swaging so that after the bearing element 24 has been assembled, material is plastically deformed from the connector 12 radially outward to constrain the location of the manifold 14. An alternative swaging method includes externally swaging material on the manifold 14 into a groove at location “A” on the connector 12. Still other alternative retainers or retaining features include placing an internal or external clip, pin, locking fastener or wire at location “A” that is proud of the outer diameter of the connector 12, such as the V-clip 31 shown typically in FIG. 3. Additional alternative retaining methods include welding a proud surface internally or externally on the connector 12 or manifold 14 to prevent disassembly, or similar to the swaging geometry, using a thermal assembly method to deform the components so they are interfering. Additionally, the geometry or geometries of components could be formed or swaged to create alternative interfering features.

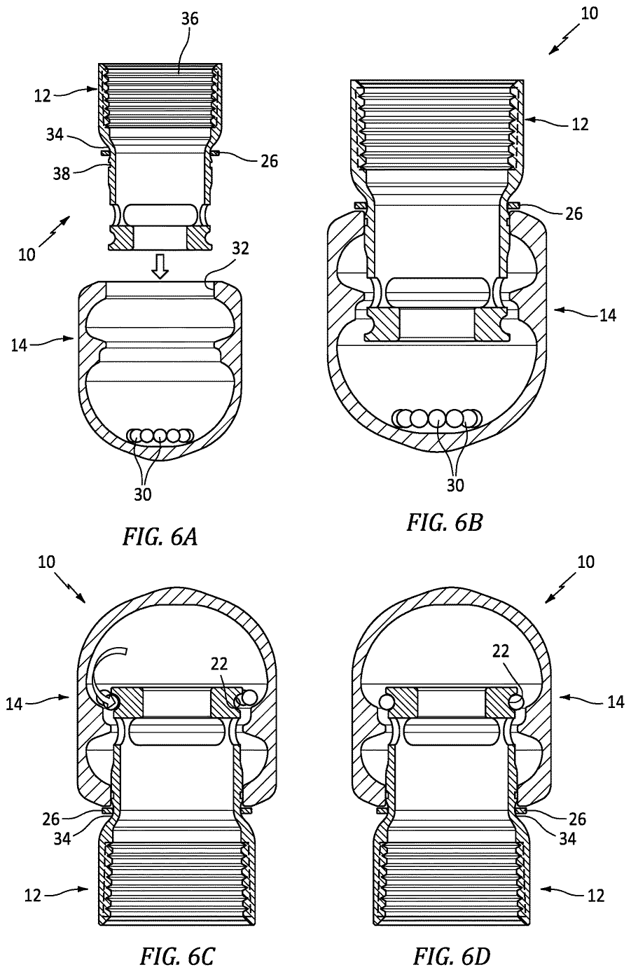

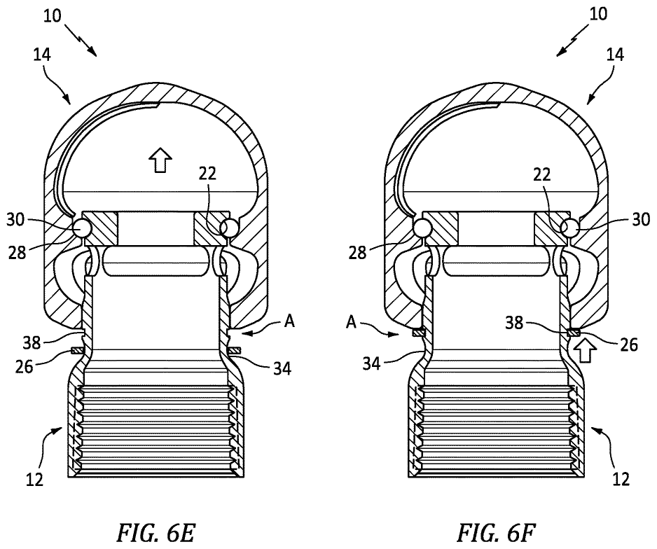

As shown in FIGS. 6A through 6F, the nozzle 10 is assembled via the retaining ring 26 method in accordance with the following steps:
Step 1: As shown in FIG. 6A, hold the manifold 14 so that the inlet bore 32 is facing upward. Place the ball bearings 30, 30 into the manifold 14, slide a retaining ring 26 over the non-threaded end of the connector 12 and place it on the service groove 34 of the connector 12.
Step 2: As shown in FIG. 6B, take the connector 12 and place it into the manifold 14, seat the connector 12 as far into the manifold 14 as the parts allow without having to apply additional force.
Step 3: As shown in FIGS. 6C and 6D, while nested, flip the parts (i.e., the connector 12 nested within the manifold 14) upside down so the connecter 12 is now pointed towards the ground. The internal geometry of the manifold 14 is constrained so that under gravity the bearings 30, 30 locate on the inner bearing race 22 of the connecter 12.
Step 4: As shown in FIG. 6E, once the bearings 30, 30 are placed in the inner bearing race 22, the manifold 14 can be pulled away from the connecter 12 (i.e., distally or in the downstream direction), the bearings 30, 30 will now be contacting the outer race 28 of the manifold 14 and the inner race 22 of the connector 12.
Step 5: As shown in FIG. 6F, once the bearing element 24 is assembled, move the retaining ring 26 into the assembly lock groove 38 at location “A” on the connector 12. The nozzle 10 is now assembled.

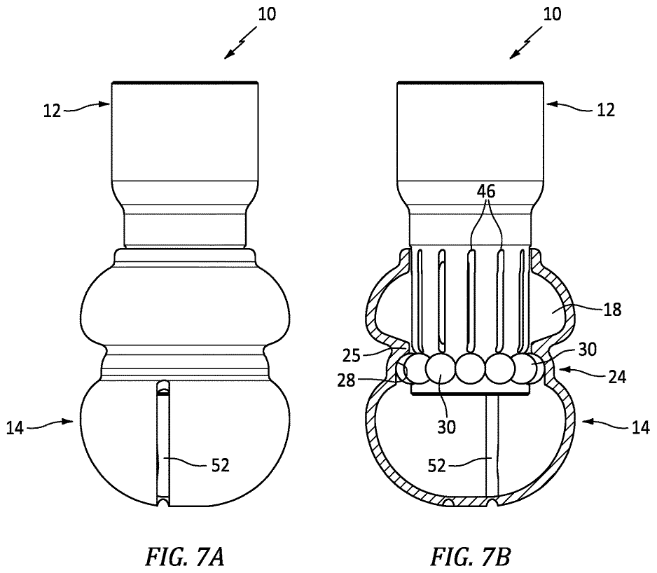

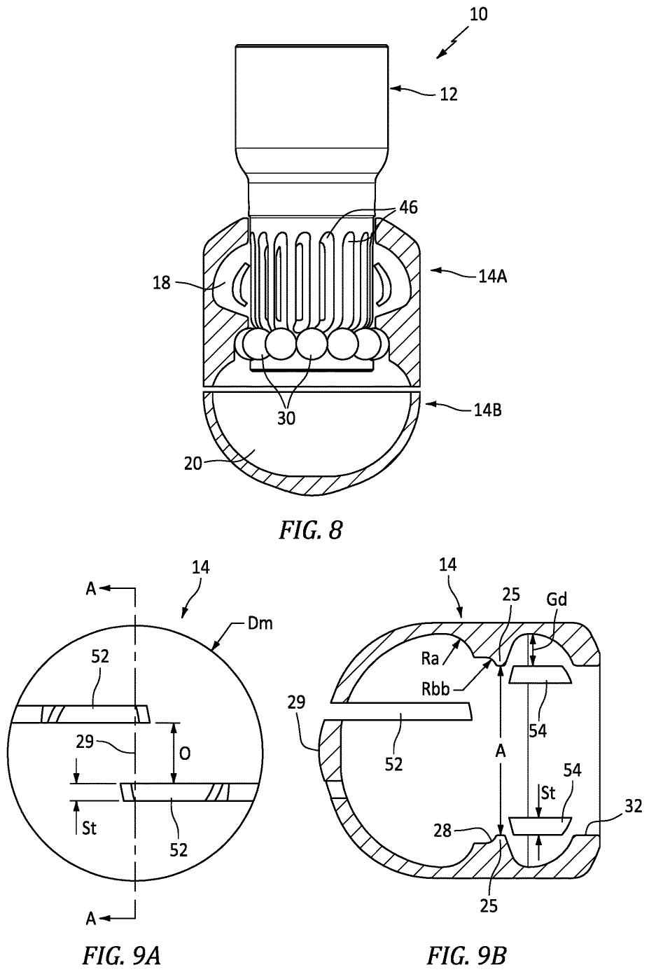

As may be recognized by those of ordinary skill in the pertinent art based on the teachings herein, alternative to the assembly method described above, the benefits of the disclosed bearing configuration could be achieved through other methods, including without limitation, metal spinning forming, hydroforming (see FIGS. 7A and 7B), or having a two component manifold joined before or after the bearing assembly by joining methods, such as welding, friction, threads, additional pins, clips, or fasteners (see FIG. 8). Alternatively, using methods of additive manufacturing or forming methods, the manifold 14 could be created around a connector 12 with a bearing element in place already.

The inner and outer bearing races 22 and 28, respectively, are non-overlapping and are designed to freely slide past one another. As shown in FIGS. 9A through 10B, on the manifold 14, there is no internal diameter smaller than the outer diameter “B” on the connector/stem 12, and on the connector/stem 12, there is no outer diameter within the length “Al” that is larger than the inner diameter “A” of the manifold 14. The outer diameter “B” of the connector/stem 12 is smaller than inner diameter “A” on the manifold 14 to ensure assembly of the connector within the manifold is possible. In the illustrated embodiment, the bearing assembly 24 geometry has been designed according to the guidelines hereinafter set forth.

With respect to the manifold defining dimensions, as shown in FIGS. 9A and 9B, the bearing race radius is defined as “Rbb,” where this radius approximately matches or is substantially equal to the radius of the ball bearings 30, 30 used for the nozzle 10. The manifold's internal radius “Ra” also is approximately equal to the diameter of the ball bearings 30, 30, and this is the track the ball bearings use to roll into the inner race 22 on the connector 12. The axial distance of “Ra” to “Rbb” should be greater than or approximately equal to one ball bearing 30 diameter to ensure the bearings have clearance to freely locate between the inner and outer races 22 and 28, respectively.

With respect to the connector defining dimensions, as shown in FIGS. 10A and 10B, the connector 12 dimension “Al” is constrained to be the location of where the inlet 32 of the manifold 14 must be located to allow the bearings 30, 30 to freely locate in the inner bearing race 22 on the connector 12. The connector length “Ro” is the offset distance from “Al” that the manifold 14 must move to either assemble or disassemble the nozzle 10. The distance “Ro” plus a clearance length is where the swaging or retaining ring 26 must be located to prevent disassembly. The connector dimension “Dc” is the largest diameter on the connector 12, and should be sized to be larger than the process connection plus sufficient wall thickness, but remain smaller than the manifold's diametric dimensions “A” and “Gd” combined.

Rather than scaling the dimensions of the nozzle up to increase the flow rate and service life for a similar pressure, as encountered in prior art rotating spray nozzles, the spray nozzle 10 includes a tank-washing ball bearing assembly 24 that can be placed into the manifold 14 which, in an effective tank washer, is the largest diameter component to minimize spray shadowing. Accordingly, one advantage of the nozzle 10 is that placement of the ball bearings 30, 30 into the manifold 14 minimizes common design limitations related to sizing of the ball bearings, and the location and inner diameter of the ball bearing assembly.

The inner and outer bearing races 22 and 28, respectively, are designed so that the bearings 30, 30 are completely captured when concentrically and axially aligned, but are not fully captured when the races are moved to be concentric, but axially offset from each other when not limited by the retaining element or method 26.

Another advantage of the nozzle 10 is that mounting the bearing assembly 24 inside the manifold 14 provides the unique ability to sufficiently pressurize the manifold by separating the flow between the upper and lower hemispheres or cavities 18 and 20, respectively, without an unnecessary loss to flow capacity or burden to manufacturing and cost. The inner diameter of the bearing 24 (“Dd” in FIG. 10B) can be tuned to adjust the proportion of fluid that is directed to each cavity or hemisphere 18 or 20 and ultimately the spray propagation. This design uses the restriction from the bearing assembly 24 inner diameter as spray propagation geometry. A reduction to the inner diameter of the bearing assembly 24 will increase the flow capacity to the upper hemisphere 18 of the manifold 14 and the upper portion of the spray propagation. The load from this flow restriction is distributed on the connecter 12 rather than the ball bearings 30, 30 due to the integrated bearing race 22 on the connector 12. This has a positive effect on the service life of the bearings 30, 30 as the axial load they experience is mainly caused by the manifold's lower hemisphere 20 static pressure.

Yet another advantage of the tank washing nozzle 10 is that placing the tank washing bearing assembly 24 in the manifold 14 allows for more complete drainage of fluids from the bearings independent of nozzle orientation. During operation, the fluid used to flush the bearings 30, 30 is then used for spray propagation.

Yet another advantage of the spray nozzle 10 is that the seated bearings 30, 30 act as the retaining element to prevent disassembly while the nozzle 10 is pressurized.

Without the bearings 30, 30 in place, the manifold 14 and the connector 12 can be disassembled. The ball bearings 30, 30 act as a method of joining the two parts together by introducing a constrained overlapping surface, and act as a rotary joint to allow the manifold 14 to rotate. The nozzle 10 can operate in any orientation as long as the bearings 30, 30 are properly loaded. The bearings 30, 30 are designed so that they are properly loaded if there is sufficient fluid supply 16 pressure. The further retaining method of a retainer 26, such as a ring, clip, or swaging, prevents disassembly from other external forces.

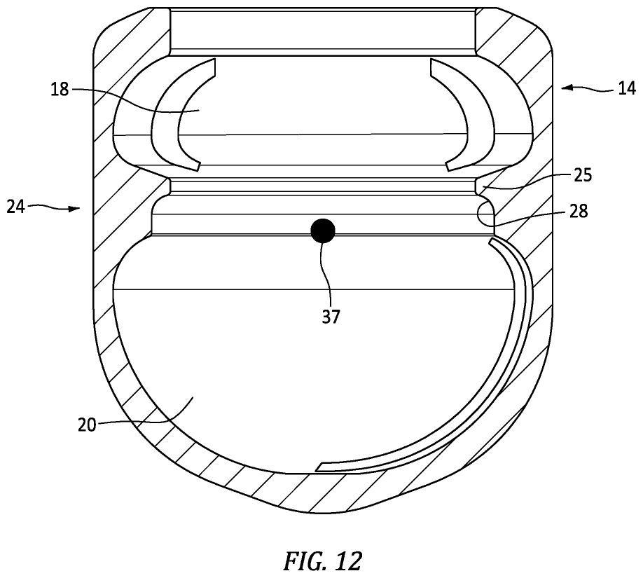

Another advantage of the spray nozzle 10 is that the bearing element 24 can be located inside the manifold 14 itself and can be designed so that the center of mass 37 of the rotating manifold (FIG. 12) can be located axially near the bearing element. The axial distance between the center of the bearing element 24 and the center of mass 37 of the manifold 14 should be less than or equal to about 150% of the bearing element diameter. One advantage of this design characteristic is that it can greatly reduce the imbalance of the rotating manifold as encountered in the above-described prior art. Without the additional forces from the manifold imbalance, the bearing element will experience a greater uniform distribution of axial load and increased service life.

As indicated above, prior art tank washing nozzles are commonly designed to have more than one bearing element to help reduce the imbalance from the cantilevered rotating manifold and allow for operation of the nozzle independent of orientation. One advantage of the spray nozzle 10 is that reducing the number of bearing elements reduces the total size of the nozzle as well as manufacturing costs. As shown in FIG. 12, another advantage of the spray nozzle 10 is that balancing the center of mass 37 of the rotating manifold 14 near the bearing element 24 makes designing for a single bearing element more achievable. As may be recognized by those of ordinary skill in the pertinent art based on the teachings herein, the bearings and the bearing assemblies of the spray nozzle 10 may take any of numerous different configurations that are currently known, or that later become known.

For example, the bearings need not be ball bearings, but rather may be roller bearings or take other forms of rolling or sliding, low-friction element(s) that allow relative rotation of the manifold about the stem. As one example shown in FIG. 20, the bearing assembly 24′ includes a sliding bearing 30′ in lieu of the ball bearings 30, 30. The slide bearing 30′ is made of low friction material(s) and/or surface finish in a manner known to those of ordinary skill in the pertinent art. In the illustrated embodiment, the slide bearing 30′ is in the form of a split ring, as shown, in order to facilitate assembly of the sliding bearing over the flange 23 of the connector/stem 12. However, the sliding bearing 30′ alternatively could be provided in a coiled or spiral form to facilitate assembly over the flange of the connector stem. One potential advantage of the sliding bearing, as opposed to roller bearings, for example, is that the sliding bearing may rotate more slowly and thereby improve spray impact and coverage.

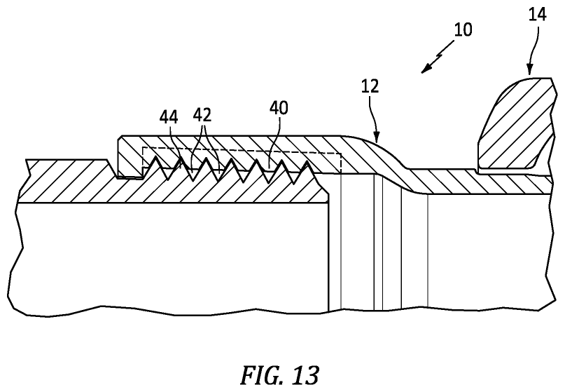

Prior art tank washing nozzles are commonly connected to a fluid supply via pipe threads, a weld, or a slip fit and locking pin method (e.g., as shown in FIG. 3). Pipe threads are used on pipes and fittings to form a pressure-tight seal to prevent process fluid leakage by setting the male and female threads at a taper angle relative to the center line. As the male thread is screwed into the female thread, the major diameter of the male thread increases due to the taper and at a determined depth intersects with the female thread. A pressure seal is formed by the close fit of the threads with imperfections filled by PTFE or Teflon® tape. In tank cleaning applications, the ability of the nozzle to have a free drainage path for fluids is a key performance characteristic. The slip fit and locking pin method is an industry standard, accepted hygienic connection type. Key characteristics for this type of connection to meet hygienic standards are the polished male and female surfaces meeting a specific surface finish, and the designed gap between the male and female connection surfaces. This gap gives the fluid a clear path to drain from the nozzle without being entrapped and promoting microbial growth. One advantage of the spray nozzle 10 is that it employs a novel design to achieve a higher degree of hygienics for applications that require a pipe thread connection. As shown in FIG. 13, by removing the crest of the female pipe thread 40, a continuous spiral channel 42 is created along the thread between the female thread 40 and male thread 44 that allows fluid to drain during and after cleaning operations of the spray nozzle 10. The female thread 40 is manufactured to meet quality requirements for the pipe thread female major diameter to ensure the thread maintains its structural integrity to securely connect the spray nozzle 10 to the fluid supply 16. A slip fit and locking pin method, as shown, for example, in FIG. 3, typically has a designed continuous gap of 0.005 inch between the male and female surfaces to allow a fluid path. The illustrated thread design reduces the female thread height by about 50%. Another advantage of this design is that it eliminates the need for thread tape which, in turn, eliminates another potential source of contamination and clogging. As may be recognized by those of ordinary skill in the pertinent art based on the teachings herein, the hygienic thread design as shown, for example, in FIG. 13, can be used in any type of tank washing or other type of spray nozzles, including rotating and non-rotating spray nozzles.

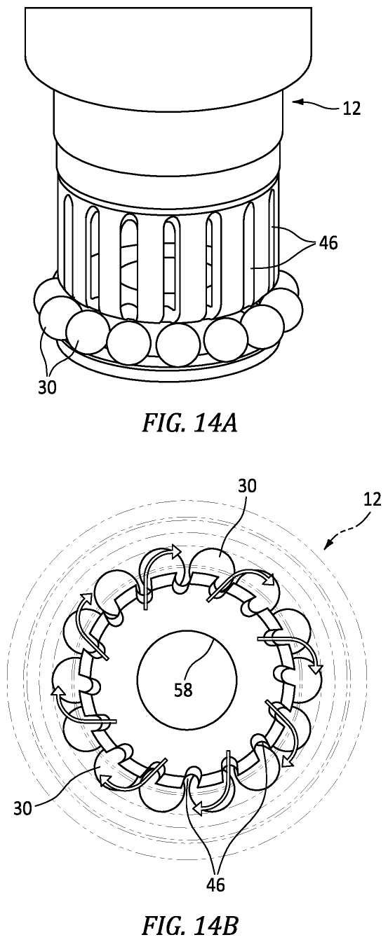

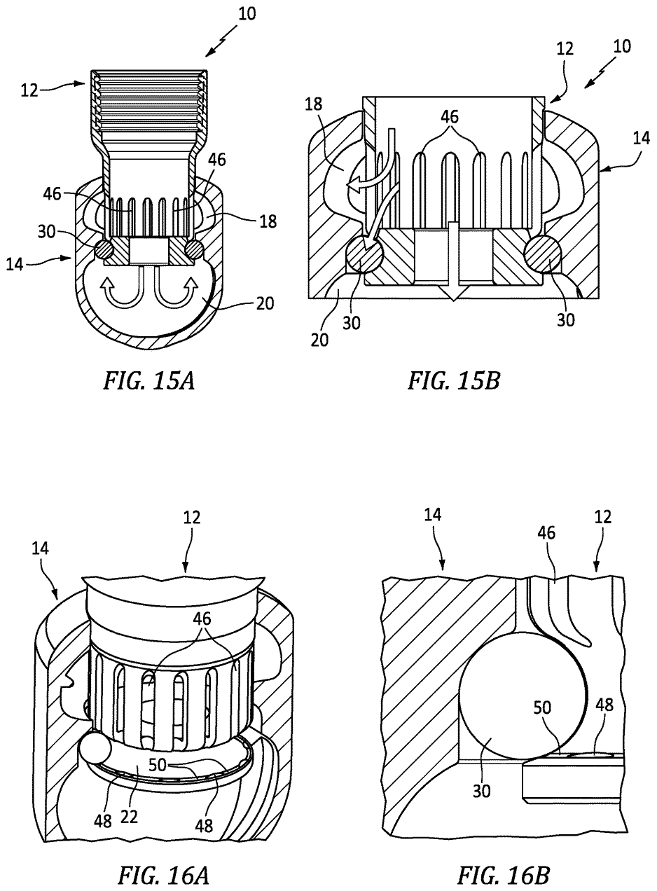

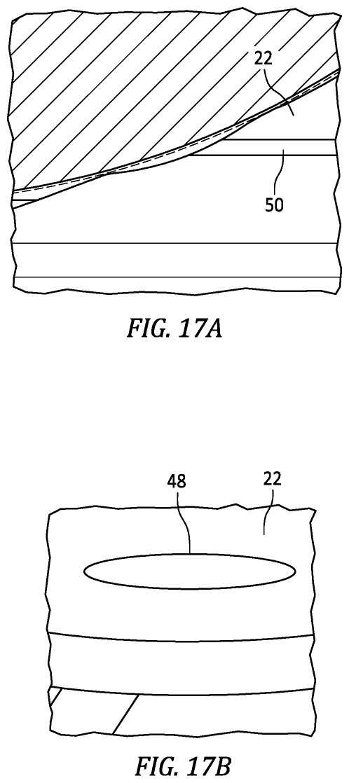

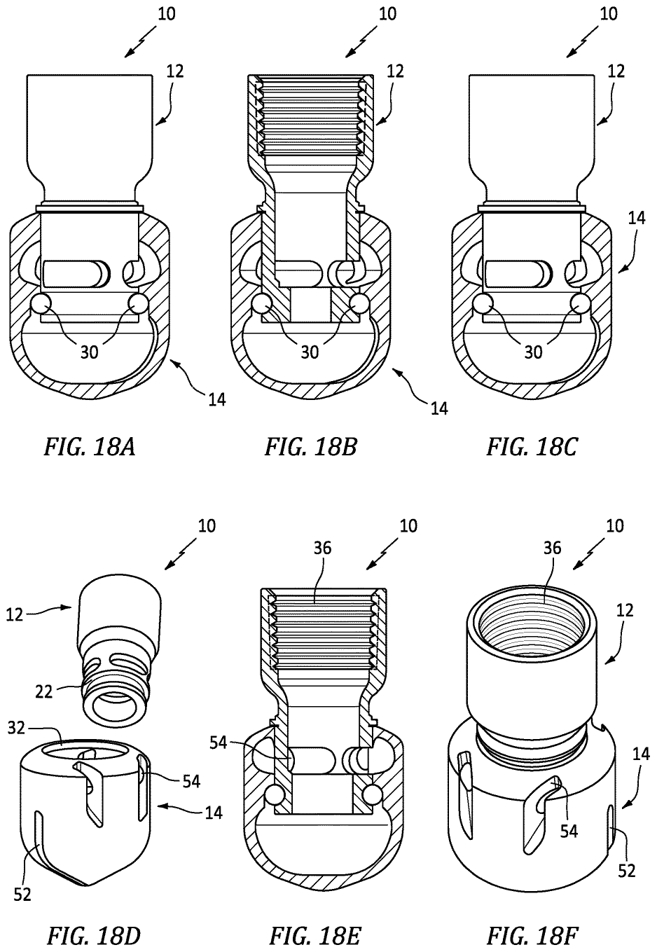

Tank washing nozzles can use a set of angled or straight stator vanes to impart a controlled amount of rotational speed to the supply water, which then washes over a set of angled or straight rotor vanes. With a specified difference in angle, this type of design can achieve high starting torques, but with comparably low top speeds. As shown typically in FIGS. 14A and 14B, in the illustrated embodiment of the spray nozzle 10, the stator is defined by angled diffuser slots 46, 46 built into the connector 12. As shown in FIGS. 14A and 14B, the diffuser slots 46, 46 are angularly spaced relative to each other about the periphery of the connector 12, extend axially along the length of the connector approximately throughout the axial length of the upper cavity or hemisphere 18 of the manifold 14 to place the interior of the manifold in fluid communication with the connector, and extend radially inwardly on their distal or downstream ends into the inner bearing race 22 to place the connector in fluid communication with the bearing assembly 24 and ball bearings 30, 30 assembled therein. As shown in FIGS. 15A and 15B, the rotor, on the other hand, is defined by both the surfaces of the inner manifold 14, and the bearing ball elements 30, 30. As indicated by the arrows, the supply fluid flow moves through the drive diffuser slots 46, 46 of the connector 12 pressurizing the upper hemisphere 18 of the manifold 14 for spray propagation purposes, but also creating a rotating shell of water which impacts and washes over the bearing ball elements 30, 30, carrying them along in the current.

The total collective torque on the bearing balls 30, 30 is:
(a) Zero if the bearing balls 30, 30 are moving at the same speed as the rotating shell of water;
(b) Increasingly positive if the bearing balls 30, 30 are moving slower than the rotating shell of water; and
(c) Increasingly negative if the bearing balls 30, 30 are moving faster than the rotating shell of water.

The above features can also be paired with opposing drive slots on the manifold 14, giving even finer control over the “Pressure vs Torque vs Rotation Speed” response surface. One goal of the illustrated embodiment of the spray nozzle 10 is to have a high starting torque which stays high but drops off sharply once the desired rotation speed has been achieved, and is mostly independent of supply pressure.

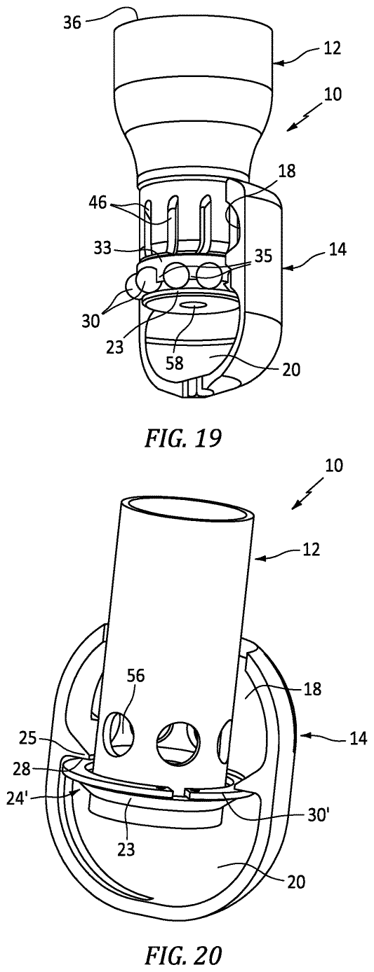

In the tank washing nozzle 10, the bearing assembly 24 contains a determined number of rolling ball elements 30, 30 depending on its size. Ideally, the friction experienced by the rolling elements 30, 30 is limited to their contact points on the inner and outer races 22 and 28, respectively, of the bearing assembly 24. However, a disruption to the drive torque or speed of the rotating mass could cause the spacing between the rolling elements 30, 30 to be changed resulting in the bearings 30, 30 contacting one another. Such contact between rolling elements can add significant friction, with the contacting rolling elements rotating in the same direction, the relative velocity can cause the bearings to have accelerated wear characteristics and cause rotation resistance. As shown in FIG. 19, one method of minimizing such rolling element grinding is to add a bearing separator or cage 33 to the assembly to give each rolling element 30, 30 space to rotate without bumping into one another. As can be seen, the bearing cage 33 includes a ring-shaped base, such as a split-ring for assembly over the connector/stem 12, that rotates with the ball bearings 30, 30, and a plurality of bearing separators or tines 35, 35 that extend from the ring-shaped base between adjacent ball bearings 30, 30 to separate the ball bearings and prevent them from contacting each other.

Another method is the use of grease to mechanically separate bearing balls by the fluid pressure of the thin film. However, one drawback with grease is that it could be relatively quickly washed out, causing contamination of the fluid media and poor lubrication soon after. The bearing cage 33, on the other hand, may be used to overcome this problem.

In an alternative embodiment of the spray nozzle 10 as shown in FIGS. 16A-17B, the nozzle 10 may be configured to meet the desired service life requirements without the need for a bearing cage. In this embodiment, the spray nozzle 10 includes a plurality of serrations 48, 48 introduced at the contact point of the bearings 30, 30 on the inner race 22 of the connector 12. On a visually smooth bearing race there are no features to regulate the speed, or location of the bearings relative to one another. The serrations 30, 30, which also may be described as divots, substantially form an ellipse at the contact point of the bearings 30, 30. This ellipse is designed to change the speed of each ball bearing 30, 30 as it travels across it. As the ball bearing 30 encounters the respective substantially elliptical-shaped divot 48, the ball's rotational velocity is reduced as the contact angle is constantly increasing until the ball reaches the midpoint of the elliptical-shaped divot 48. Then, once the ball bearing has traveled past the midpoint of the ellipse, the rotational velocity increases as the contact angle decreases. This speed variation from the divots 48, 48 allows the bearings 30, 30 to regularly separate within the rotational cycle of the nozzle 10 so that without a bearing cage the grinding is reduced sufficiently enough so that the nozzle 10 can meet its desired service life. The divots 48, 48 should be dimensioned so that they are not deep enough or wide enough for the ball bearings 30, 30 to fall within the divots and disengage from both the outer and inner bearing races 28 and 22, respectively.

Also in the illustrated alternative embodiment, a transition groove 50 is formed between the divots 48, 48 on the inner bearing race 22. The transition groove 50 is configured to keep the bearings 30, 30 approximately aligned with the entry and exit points of the elliptical-shaped divots 48, 48. As the inner race 22 wears in, the transition groove 50 wears away with it as the bearings 30, 30 find their optimal path between the divots 48, 48.

As may be recognized by those of ordinary skill in the pertinent art based on the teachings herein, the transition groove 50 may or may not be needed and the number of divots 48, 48 can be as few as one per bearing assembly, can match the number of bearings 30, 30 in the assembly, or can be a number in between. In addition, the nozzle 10 may include a different number of serrations or divots than shown, and they may define a shape other than elliptical that, for example, nevertheless causes the ball bearings to change speed or decelerate and accelerate (or vice versa) and maintain sufficient separation between the bearing elements during each rotational cycle to achieve a desired wear or service life.

As indicated above, the inner and outer bearing races 22 and 28, respectively, are non-overlapping and are designed to freely slide past one another. To ensure assembly of the connector/stem 12 within the manifold 14 is possible, the outer diameter “B” of the connector/stem 12 is smaller than inner diameter “A” on the manifold 14. As shown in FIGS. 9A through 10B, on the manifold 14, there is no internal diameter smaller than the outer diameter “B” on the connector/stem 12, and on the connector/stem 12, there is no outer diameter within the length “Al” that is larger than the inner diameter “A” of the manifold 14. In the illustrated embodiment, there is no internal diameter on the manifold 14 smaller than diameter A, and on the connecter 12, no diameter within the length Al is larger than Diameter B.

As shown in FIG. 9B, the radius of the outer bearing race 28 of the manifold 14 is defined as Rbb. This radius matches the radius of the ball bearing 30, 30 used for the nozzle. The internal radius Ra of the lower cavity 20 of the manifold 14 is approximately equal to the diameter of the ball bearing 30. The internal radius Ra defines the track the ball bearings 30, 30 use to roll into the inner race 22 on the connector 12. The internal manifold dimension Gd (i.e., the radial depth of upper cavity 18 beyond the diameter A) functions to create a volume for the water or other liquid to pressurize in the upper manifold hemisphere 18 to fill in the upper pattern of the spray propagation. The diametric value of Gd must be greater than the connector diameter Dc to ensure self-cleaning. The outer diameter Dm of the manifold 14 must be smaller than the inlet port of the tank that the nozzle is intended for (not shown). Dm also must be greater than the connector dimension Dc to ensure self-washing.

The manifold 14 may include one or more drive slots or spray apertures 52, 52 formed through the external wall of the lower cavity or hemisphere 20 and one more drive slots or spray apertures 54, 54 formed through the external wall of the upper cavity or hemisphere 18. As shown typically in FIG. 9B, each slot 52, 52 extends axially along substantially the axial length of the lower cavity or hemisphere 20, and follows the external wall of the lower hemisphere such that it curves radially inwardly toward the center or axis of rotation of the manifold. The manifold slot dimension “O” is the offset between the drive slots 52, 52 in the lower hemisphere 20 of the manifold 14. This is a driving dimension for the rotational speed of the manifold 14. The upper slots 54, 54 also extend through and follow the curvature of the exterior wall of the upper hemisphere of the manifold 14, and extend axially substantially along the axial length of the upper hemisphere. Each of the lower slots 52, 52 and upper slots 54, 54 defines a manifold slot dimension or width “St” which is the final flow restriction for the process fluid. An increase or decrease in the manifold slot dimension St will have a proportional effect on the flow capacity of the nozzle 10. The drive slots 52, 52 and 54, 54 and their above-mentioned dimensions are designed to restrict the flow enough to create back pressure to substantially uniformly pressurize the manifold 14. As may be recognized by those of ordinary skill in the pertinent art based on the teachings herein, the slots/apertures may take any of numerous configurations and dimensions, and the manifold may define any desired or required number of such slots or other apertures, that are currently known, or that later become known.

As shown in FIG. 10B, the connector dimension “Al” is constrained to be the location of where the inlet of the manifold 14 must be located to allow the bearings 30, 30 to freely locate in the inner bearing race 22 on the connector 12. The connector length “Ro” is the offset distance that the manifold 14 must move for either assembly or disassembly. The distance “Ro” plus a clearance length is where the swaging or retaining ring 26 must be located to prevent disassembly. The connector dimension “Sw” defines the axial width of the radial outlet 56 of the fluid from the connector 12 into the upper hemisphere 18 of the manifold 14. This fluid path characterizes the upper spray propagation. The connector dimension “Dd” is the diameter of the connector's diffuser 58. This diameter is the axial outlet of the fluid from the connector 12 into the lower hemisphere 20 of the manifold 14.

This fluid path characterizes the lower spray propagation. This diameter “Dd” also is a driving dimension in determining what portion of the fluid is directed to the connector's radial outlets 46, 46. The connector dimension “Dc” is the largest diameter on the connector 12. This diameter Dc must be sized to be larger than the process connection plus sufficient wall thickness, but remain smaller than the diametric dimensions A and Gd of the manifold 14 combined.

One advantage of the spray nozzles of the present invention, and/or of the embodiments thereof, is that they can be lighter, significantly smaller in diameter and length, and more balanced in comparison to prior art rotating spray nozzles. Yet another advantage is that the spray nozzles can have more hygienic threads and/or internals. A still further advantage is that the spray nozzles can be assembled and disassembled. If desired, the bearings can be replaced to extend the life of the nozzle. Yet another advantage is that all surfaces can be machined to improve consistency and control over surface finish. Yet other advantages are that the spray nozzles can provide for smoother spinning and more consistent coverage, greater cleaning power and greater impact resistance. Yet another advantage is that the spray nozzles do not require any welds or press fits, if desired, and they can eliminate dead zones. Yet another advantage is that the spray nozzles can be fully self-draining, including the threads. A still further advantage is that the bearings are located in the spray propagation geometry to thereby ensure continuous flushing and draining.

As may be recognized by those of ordinary skill in the pertinent art based on the teachings herein, numerous modifications, changes and/or additions may be made to the above-described and other embodiments of the present invention without departing from the scope of the invention as defined in the claims. For example, the spray nozzles may include additional components or fewer components, the components may be made of any of numerous different materials, and/or may take any of numerous different shapes and/or configurations, that are currently known or that later become known. In addition, the shapes and/or configurations of the spray nozzles, connectors, inlets, stems, manifolds, bearings, and retainers, may take any of numerous different configurations or forms, and/or may be made of any of numerous different materials, and in accordance with any of numerous different processes, that are currently known or that later become known. In addition, the spray nozzles may be used, and configured for use, in connection with any of numerous different types of equipment or processes that are currently known, or that later become known, including for tank washing or other applications, where the spray nozzles are rotating or non-rotating configurations. Further, the components of the spray nozzles may be connected to each other in any of numerous different ways that are currently known, or that later become known, including by welding, threaded connections, by fasteners, and/or by adhesives. The configurations and/or materials of the nozzles, components, and their assembly, may be selected as dictated by a particular process or system for making, assembling and/or using the spray nozzle. Accordingly, this detailed description of embodiments is to be taken in an illustrative, as opposed to a limiting sense.

1. A rotating spray nozzle connectible in fluid communication with a liquid supply and configured to spray liquid from the liquid supply, comprising:
a liquid inlet connectible in fluid communication with the liquid supply and configured to receive liquid therefrom;
a stem extending in a downstream direction relative to the liquid inlet and in fluid communication and substantially coaxial therewith;
a manifold substantially coaxial with and extending about the stem, wherein the manifold defines an upper interior cavity, a lower interior cavity, a plurality of spray apertures in an exterior wall thereof, and a reduced-diameter section located between the upper interior cavity and the lower interior cavity and defining a reduced inner diameter; and
a bearing configured to allow the manifold to rotate about the stem;
wherein the stem defines an upper flow path upstream of the bearing and configured to introduce liquid from the stem into the upper interior cavity of the manifold, and a lower flow path downstream of the bearing and configured to introduce liquid from the stem into the lower interior cavity of the manifold, the stem includes a flange extending radially therefrom and defining an outer diameter less than the inner diameter of the reduced-diameter section of the manifold and an inner bearing surface substantially facing the liquid inlet, and the reduced-diameter section of the manifold defines an outer bearing surface axially spaced from and substantially facing the inner bearing surface of the flange, wherein the bearing is received between the inner bearing surface and the outer bearing surface and is configured to (i) allow the manifold to rotate about the stem, and (ii) retain the rotating manifold on the stem against a liquid supply pressure of the liquid flowing into at least one of the upper interior cavity or the lower interior cavity.

2. A rotating spray nozzle as defined in claim 1, wherein the manifold is formed in one piece and/or the manifold defines a distal end wall that curves inwardly toward an axis of rotation of the manifold.

3. A rotating spray nozzle as defined in claim 2, comprising a bearing assembly including a plurality of said bearings received between the inner bearing surface and the outer bearing surface.

4. A rotating spray nozzle as defined in claim 3, wherein the spray nozzle comprises only one said bearing assembly.

5. (canceled)

6. A rotating spray nozzle as defined in claim 1, wherein the stem defines a plurality of fluid flow apertures therein defining at least one of the upper flow path or the lower flow path, and each of a plurality of the apertures defines at least a portion thereof extending through a substantially radially-directed wall of the stem.

7. A rotating spray nozzle as defined in claim 6, wherein the apertures formed through the radially-directed wall of the stem are angled to cause the liquid flowing through the angled aperture to impart rotating motion on the manifold.

8. A rotating spray nozzle as defined in claim 1, further comprising a retainer located on the inlet or stem upstream of the manifold and configured to substantially prevent the manifold from moving axially relative to the stem in an upstream direction.

9. A rotating spray nozzle as defined in claim 8, wherein the retainer defines (i) a service position or configuration wherein the manifold is movable axially relative to the stem to define an increased axial distance between the inner bearing surface and outer bearing surface and thereby allow the bearing to be received between the inner bearing surface and outer bearing surface, and (ii) an operational position or configuration substantially preventing the manifold from moving axially relative to the stem in an upstream direction and defining a decreased axial distance between the inner bearing surface and outer bearing surface to thereby retain the bearing between the inner bearing surface and the outer bearing surface.

10. A rotating spray nozzle as defined in claim 9, wherein the inlet or stem defines a recess or groove, and the retainer is received within the recess or groove in the operational position to fix the axial position of the retainer and substantially prevent the manifold from moving axially relative to the stem in an upstream direction, wherein the retainer is one or more of a ring, a clip, a wire, a dowel pin, a threaded, crimped or welded fastener, a rivet, a gasket or an O-ring:
or
the retainer is defined by a raised portion on one of the stem or the manifold and a reduced portion on the other of the stem or manifold and configured for receiving the raised portion, wherein the reduced portion is formed by a swage, a weld, a crimp, a thermal deformation, or a machined part formed or spun into a retainer.

11-13. (canceled)

14. A rotating spray nozzle as defined in claim 1, wherein the inlet or tube defines a first pipe thread engageable with a second pipe thread of a liquid supply conduit, wherein one of the first pipe thread or second pipe thread is configured to receive the other therein and define a continuous spiral channel between the first and second pipe threads, and the continuous spiral channel is in fluid communication between the interior of the inlet or stem and the exterior of the nozzle and is configured to allow liquid to flow therethrough.

15. (canceled)

16. A rotating spray nozzle as defined in claim 1, wherein the bearing defines a center point in an axial direction of the spray nozzle, the manifold defines a center of mass, and an axial distance between the center point of the bearing and the center of mass of the manifold is less than or equal to about 150% of a diameter or width of the bearing element.

17. A rotating spray nozzle as defined in claim 16, wherein the bearing includes at least one bearing race defining a width in the axial direction and at least one ball bearing defining a diameter, and the axial distance between the center of mass of the manifold and the center of the bearing race or the center of the ball bearing is less than or equal to about 150% of the diameter of the ball bearing or the width of the bearing race.

18. A rotating spray nozzle as defined in claim 17, wherein the center of mass of the manifold is aligned with, or located within the diameter of the ball bearing or the width of the bearing race;
and/or
wherein the at least one ball bearing and at least one bearing race form a bearing assembly, and the spray nozzle includes only one said bearing assembly rotatably mounting the manifold on the stem.

19. (canceled)

20. A rotating spray nozzle as defined in claim 1, wherein the bearing includes at least one bearing race and a plurality of roller bearings configured to roll over the bearing race and thereby allow relative rotation of the manifold and stem, wherein the bearing race defines a least one serration or divot configured to contact the roller bearings, and the serration or divot defines a peripheral shape configured to change the speed of the roller bearings as they roll across the serration or divot and thereby separate the roller bearings.

21. A rotating spray nozzle as defined in claim 20, wherein the serration or divot defines a substantially elliptical peripheral shape;
and/or
wherein the bearing race defines a plurality of serrations or divots angularly spaced relative to each other, each serration or divot defines a roller bearing entry point at approximately one end thereof, and a roller bearing exit point at approximately another end thereof, and at least one transition groove extending between angularly spaced serrations or divots and configured to contact the roller bearings and approximately align the roller bearings with at least one of the entry point or exit point of a respective serration or divot.

22. (canceled)

23. A method of assembling a rotating spray nozzle, comprising:
(i) introducing at least one bearing into a lower interior cavity of a manifold;
(ii) inserting a distal end of a stem into at least an upper interior cavity of the manifold, locating a relative position of the manifold and stem into a first position defining an increased space between an inner bearing surface and an outer bearing surface, and tilting or moving the nozzle relative to the horizontal to cause the bearing to be received into the increased space between the inner bearing surface and outer bearing surface; and
(iii) moving the manifold and/or stem relative to the other into a second position defining a decreased space between the inner bearing surface and outer bearing surface and retaining the bearing between the inner bearing surface and the outer bearing surface.

24. A method as defined in claim 23, further comprising the step of preventing the manifold from moving axially relative to the stem in an upstream direction and thereby retaining the manifold in the second position.

25-27. (canceled)

28. A rotating spray nozzle connectible in fluid communication with a liquid supply and configured to spray liquid from the liquid supply, comprising:
first means connectible in fluid communication with the liquid supply for receiving liquid therefrom;
second means extending in a downstream direction relative to the first means and in fluid communication and substantially coaxial therewith for receiving liquid therefrom;
third means substantially coaxial with and extending about the second means for receiving liquid therefrom, rotating about the second means, and emitting the liquid in a spray, wherein the third means defines an upper interior cavity, a lower interior cavity, a plurality of spray apertures in an exterior wall thereof, and a reduced-diameter section located between the upper interior cavity and the lower interior cavity and defining a reduced inner diameter; and
fourth means for allowing the third means to rotate about the second means;
wherein the second means defines an upper flow path upstream of the fourth means and configured to introduce liquid from the second means into the upper interior cavity of the third means, and a lower flow path downstream of the fourth means and configured to introduce liquid from the second means into the lower interior cavity of the third means, the second means includes fifth means extending radially therefrom and defining an outer diameter less than the inner diameter of the reduced-diameter section of the third means for providing an inner bearing surface substantially facing the first means, and the reduced-diameter section of the third means defines an outer bearing surface axially spaced from and substantially facing the inner bearing surface of the fifth means, wherein the fourth means is received between the inner bearing surface and the outer bearing surface for (i) allowing the third means to rotate about the second means, and (ii) retaining the rotating third means on the second means against a liquid supply pressure of the liquid flowing into at least one of the upper interior cavity or the lower interior cavity.

29. A rotating spray nozzle as defined in claim 28, wherein the first means is a liquid inlet, the second means is s stem, the third means is a manifold, the fourth means is a bearing and the fifth means is a flange.

30. A rotating spray nozzle as defined in claim 28, further comprising sixth means for preventing the third means from moving axially relative to the second means in an upstream direction.
